(19) United States
(12) Patent Application Publication
(10) Pub. No.: US 2025/0065159 A1
(43) Pub. Date: Feb. 27, 2025

(54) SAFETY STRAP MOUNT

(71) Applicants: Jonathan R. May, Rock Rapids, IA (US); Jason Lee Stettnichs, George, IA (US)

(72) Inventors: Jonathan R. May, Rock Rapids, IA (US); Jason Lee Stettnichs, George, IA (US)

(21) Appl. No.: 18/812,599

(22) Filed: Aug. 22, 2024

Related U.S. Application Data
(60) Provisional application No. 63/534,224, filed on Aug. 23, 2023.

(51) Int. Cl. A62B 35/00

(52) U.S. Cl. CPC A62B 35/0068

(57) ABSTRACT

A safety system for mounting to a tree including a bracket including a mounting portion configured to be positioned against the tree and an extension member including a first end extending from the mounting portion and a second end spaced from the mounting portion, the second end including a safety strap coupling member operable to couple to a safety strap and a securing strap configured to couple to the mounting portion of the bracket and secure the bracket to the tree.

### CROSS REFERENCE TO RELATED APPLICATION

This application claims priority to Provisional Application No. 63/534,224, filed Aug. 23, 2023, which is herein incorporated by reference in its entirety.

### FIELD

The present disclosure relates generally to apparatuses, systems, and methods for mounting and positioning a safety strap to minimize obstruction by the safety strap during use. More specifically, the disclosure relates to apparatuses, systems, and methods for mounting a safety strap to a tree or other object in such a way that the safety strap does not interfere with movement including the use of the user's arms during use of the safety strap.

### BACKGROUND

Safety straps are commonly used to provide a backup when users are positioned a distance from the ground in order to limit injury from falling. For example, hunters often sit in tree strands for hours at a time. Tree stands provide limited space for the user to move around, but often that space or range of motion is further limited by the safety strap that is coupled to the tree. For example, typical safety straps or ropes for tree stands are typically attached around a tree and are attached to the user in case the hunter falls off of the tree stand. The safety strap is positioned such that it can obstruct or limit movement of the user about the tree stand. Such obstruction may be a result of the relative position of mounting to the tree and positioning on the user's body. This limits the user's ability to turn or move around a tree stand without the strap contacting the user's head or other body parts. As other body parts contact the safety strap, the line may become tensioned and provide resistance to the movement. This can actually result in knocking a user off-balance.

Another difficulty with current safety straps is that they are positioned in such a way that they limit use of the user's arms. For example, some safety straps may get in the way of the user being able to draw a bow or turn to aim. The safety straps may limit the range of motion for a variety of activities and thus limits both the effectiveness of the user when coupled to the safety strap and the safety of the user.

Although safety straps are intended to break the fall of a user, when the safety strap interferes with movement of the user, it can inadvertently result in secondary safety concerns. For example, when the safety strap is in the way of the user and the user is not aware, the user can become entangled in the strap and may inadvertently fall. The safety strap will break the larger fall, but other injuries can result from the smaller fall. Additionally, users may be handling objects when using the safety strap with potential for injury. This includes bows, firearms, knives, tools, and so forth.

Because of the inconvenience and interference that many safety straps pose to users, it is common that many users opt to not use a safety strap. What is needed is a safety system that provides users the ability to freely move and use their arms and hands without interference from safety straps.

### SUMMARY

The present disclosure relates to a safety system that facilitates a high degree of freedom of movement during use while providing safety to the user if an accidental fall does occur.

According to one example (“Example 1”), a safety system for mounting to a tree includes a bracket including a mounting portion configured to be positioned against the tree and an extension member including a first end extending from the mounting portion and a second end spaced from the mounting portion, the second end including a safety strap coupling member operable to couple to a safety strap and a securing strap configured to couple to the mounting portion of the bracket and secure the bracket to the tree.

According to another example (“Example 2”) further to Example 1, the safety system includes a harness and a safety strap, the harness operable to be positioned on a user and the safety strap operable to couple to the safety strap coupling member and the harness.

According to another example (“Example 3”) further to Example 2, the safety system includes at least a portion of the safety strap coupling member is operable to rotate relative to the extension member.

According to another example (“Example 4”) further to Example 3, the safety strap coupling member includes a housing coupled to the extension member; a sound dampening insert positioned in the housing; a bearing positioned against the sound dampening insert; an interface member positioned against the bearing and operable to rotate with the bearing; and a coupling member coupled to the interface member and operable to couple to a safety strap.

According to another example (“Example 5”) further to Example 1, the mounting portion includes a vertical member including a first end and a second end;
a first set of arms extending from the vertical member proximate the first end; and a second set of arms extending from the vertical member proximate the second end, wherein the securing strap includes a first securing strap operable to couple to the first set of arms and a second securing strap operable to couple to the second set of arms to secure the bracket to the tree.

According to another example (“Example 6”) further to Example 5, the first set of arms extend generally horizontally from the vertical member and define an angle from about 90 degrees to about 180 degrees therebetween and the second set of arms extend generally horizontally from the vertical member and define an angle from about 90 degrees to about 180 degrees therebetween.

According to another example (“Example 7”) further to Example 1, the bracket includes a brace coupled to the mounting portion and the extension member.

According to another example (“Example 8”) further to Example 7, the brace is rotatably coupled to one of the mounting portion and the extension member.

According to another example (“Example 9”) further to Example 1, the extension member is rotatably coupled to the mounting portion.

According to one example (“Example 10”), a bracket for mounting to a tree and securing a safety strap is provided, the bracket including a mounting portion including a vertical member configured to be positioned against a tree and at least one pair of arms configured to couple to a securing strap to couple the bracket to the tree, the at least one pair of arms operable to limit rotation of the vertical member relative to the tree when secured; an extension member including a first end extending from the mounting portion and a second end spaced from the mounting portion; and a safety strap coupling member positioned proximate the second end of the extension member and operable to couple to a safety strap.

According to another example (“Example 11”) further to Example 10, the at least one pair of arms includes a first pair of arms coupled to the vertical member at an upper portion and a second pair of arms coupled to the vertical member at a lower portion.

According to another example (“Example 12”) further to Example 10, the at least one pair of arms are angled relative to each other from about 120 degrees to about 170 degrees.

According to another example (“Example 13”) further to Example 10, the bracket includes a support bracket extending between an intermediate portion of the vertical member and an intermediate portion of the extension member.

According to another example (“Example 14”) further to Example 13, the support bracket is rotatably coupled to one of the vertical member and the extension member.

According to another example (“Example 15”) further to Example 10, the extension member is rotatably coupled to the vertical member.

According to another example (“Example 16”) further to Example 10, the safety strap coupling member includes a housing coupled to the extension member; a sound dampening insert positioned in the housing; a bearing positioned against the sound dampening insert; an interface member positioned against the bearing and operable to rotate with the bearing; and a coupling member coupled to the interface member and operable to couple to a safety strap.

According to another example (“Example 17”) further to Example 10, the bracket includes tabs defining apertures through which fasteners are secured to maintain predetermined orientations between the vertical member and the extension member.

According to one example (“Example 18”) a safety strap coupling member includes a housing configured to be coupled to a bracket for interfacing to a tree; a sound dampening insert positioned in the housing; a bearing positioned against the sound dampening insert; an interface member positioned against the bearing and operable to rotate with the bearing; and a coupling member coupled to the interface member and operable to couple to a safety strap.

According to another example (“Example 19”) further to Example 18, the housing includes a recess defined by side walls for receiving the sound dampening insert and an aperture defined through a portion of the side walls, the sound dampening insert including a recess defined by side walls for receiving the bearing and an aperture defined through a portion of the side walls, the coupling member operable to extend through at least a portion of the aperture of the sound dampening insert and at least a portion of the aperture of the housing.

According to another example (“Example 20”) further to Example 19, the bearing is defined around and configured to rotate about a central axis, the bearing defining a central aperture defined about the central axis, and wherein the interface member includes a body defining a cap portion and an extension member, the cap portion operable to interface with an upper surface of the bearing and the extension member operable to extend into at least a portion of the central aperture of the bearing.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an illustration of a safety system mounted to a tree in accordance with an embodiment;

FIGS. 2, 3, and 4 are illustrations of a bracket of the safety system of FIG. 1.

FIG. 5 is a section view of a safety strap coupling member of a bracket in accordance with an embodiment;

FIG. 6 is an exploded view of a safety strap coupling member of a bracket in accordance with an embodiment; and

FIGS. 7A, 7B, and 7C are illustrations of a bracket in a deployed configuration and a collapsed configuration, respectively, in accordance with an embodiment.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### DESCRIPTION OF VARIOUS EMBODIMENTS

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

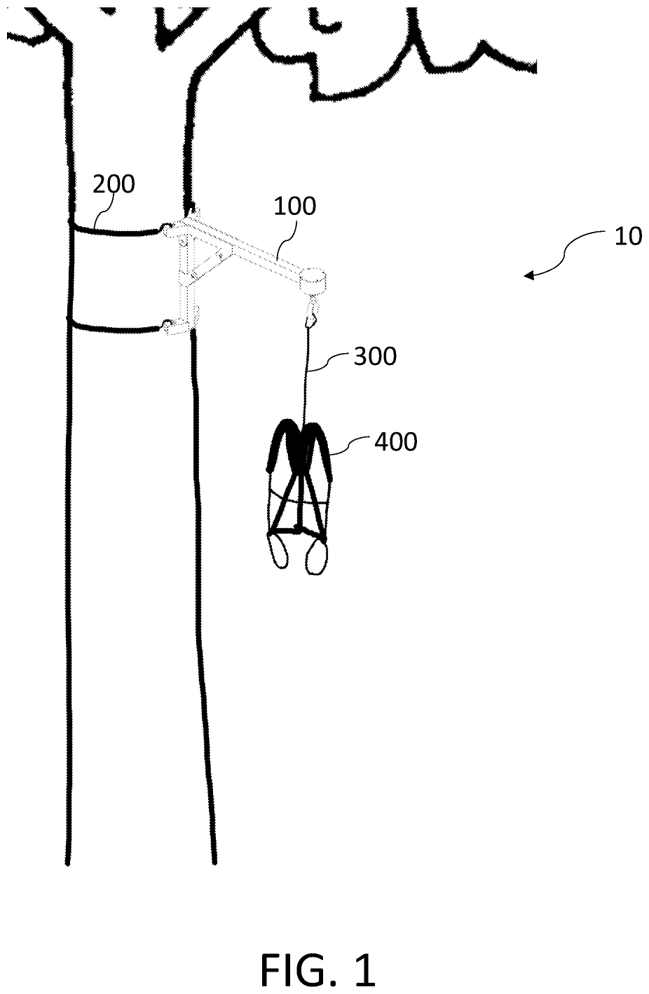

Referring to FIG. 1, a safety system 10 for mounting to a tree is illustrated. The safety system 10 may be implemented to strap a person to the safety system to ensure that a user that falls from a platform does not fall beyond the length of a safety strap to the ground. The user may have a harness that is coupled via a safety strap to the safety system 10 to limit the distance a user falls. The safety system 10 disclosed herein provides the ability to anchor to a vertical structure such as a tree while maintaining the ability to move about without a safety strap interfering with movement. Furthermore, the safety system 10 is positioned to allow increased range of motion of arms while performing various tasks. Additionally, the safety system 10 allows for quiet movement as it is configured to limit noise production during use.

The safety system 10 includes a bracket 100 configured to interface with a vertical object such as a tree, a securing strap 200 to secure the bracket 100 to the vertical object, a safety strap 300 to secure a user to the bracket 100, and a harness 400 for interfacing with the user and coupling to the safety strap 300. Various harnesses, securing straps, and safety straps may be implemented with the bracket 100 discussed herein. It is understood that the safety system 10 may be provided with the bracket 100 and a combination of some or all of the securing strap 200, safety strap 300, and harness 400. It is also understood that the safety system 10 may include only a bracket 100 and the remaining components may be provided separately. Additionally, the safety system 10 may be provided as a component of a larger kit, such as a tree stand kit and so forth.

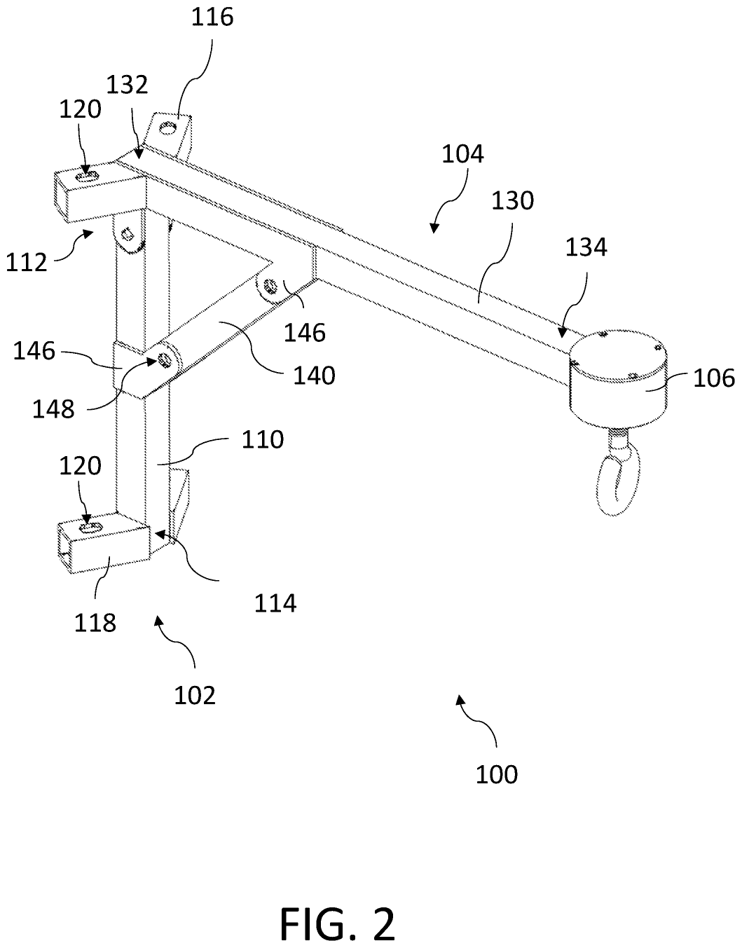

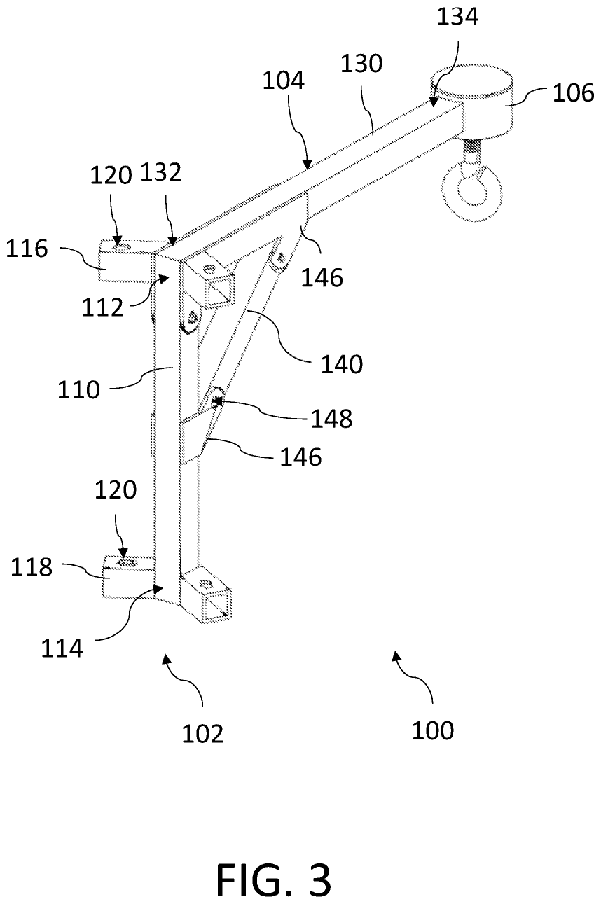

Referring to FIGS. 2 and 3, the bracket 100 is illustrated in greater detail. The bracket 100 includes a mounting portion 102 configured to be positioned against the tree and an extension member 104 configured to space a portion of the bracket 100 from the tree. The extension member 104 includes or is coupled to a safety strap coupling member 106 operable to couple to a safety strap 300.

The mounting portion 102 of the bracket 100 includes a vertical member 110 including a first end 112 and a second end 114. The vertical member 110 may include any type of support such as a tube, pipe, rod, block, and so forth and may be formed via different materials and combinations of materials (e.g., metal, metal alloys, wood, polymers, and so forth) and via various processes (e.g., extrusions, additive manufacturing, lathe, and so forth). The vertical member 110 may include various profiles such as round, curved, square, rectangular, and so forth. In one embodiment, the profile includes a substantially flat surface on the side configured to interface with the tree, thus allowing a distribution of force along the surface of the tree to limit any damage to the surface of the tree.

The mounting portion 102 of the bracket 100 further includes a first set of arms 116 extending from the vertical member 110 proximate the first end 112 and a second set of arms 118 extending from the vertical member 110 proximate the second end 114. The first and second sets of arms 116, 118 are positioned extending generally outward and horizontally from the vertical member 110. The arms 116, 118 including coupling features 120 such as apertures to which securing straps 200 may be coupled. This allows the bracket 100 to be coupled securely to the tree. Other coupling features are contemplated herein and are not limited specifically to apertures. The coupling features 120 may be provided on any of the surfaces of the arms 116, 118, including those shown herein (i.e., an upper surface of the arms 116, 118).

The arms 116, 118 are positioned such that the first set of arms 116 extend generally horizontally from the vertical member 110 (e.g., at the first end 112) and define an angle from about 90 degrees to about 180 degrees therebetween and the second set of arms 118 extend generally horizontally from the vertical member 110 (e.g., at the second end 114) and define an angle from about 90 degrees to about 180 degrees therebetween. For example the angle between the first set of arms 116 and the angle between the second the second set of arms 118 is from about 90 degrees to about 115 degrees, from about 115 degrees to about 130 degrees, from about 130 degrees to about 145 degrees, from about 145 degrees to about 160 degrees, from about 160 degrees to about 170 degrees, and from about 170 degrees to about 180 degrees. The angle between the first set of arms 116 and the angle between the second set of arms 118 may be provided to conform better to the outer surface of the tree. For example, in areas with trees with greater diameters, the angle may be greater and areas with trees with lesser diameters, the angle may be relatively less. The arms 116, 118 act to limit rotational movement or rolling of the vertical member 110 relative to or along the surface of the tree. The arms 116, 118 also act to distribute force from the bracket 100 only a greater surface area of the tree.

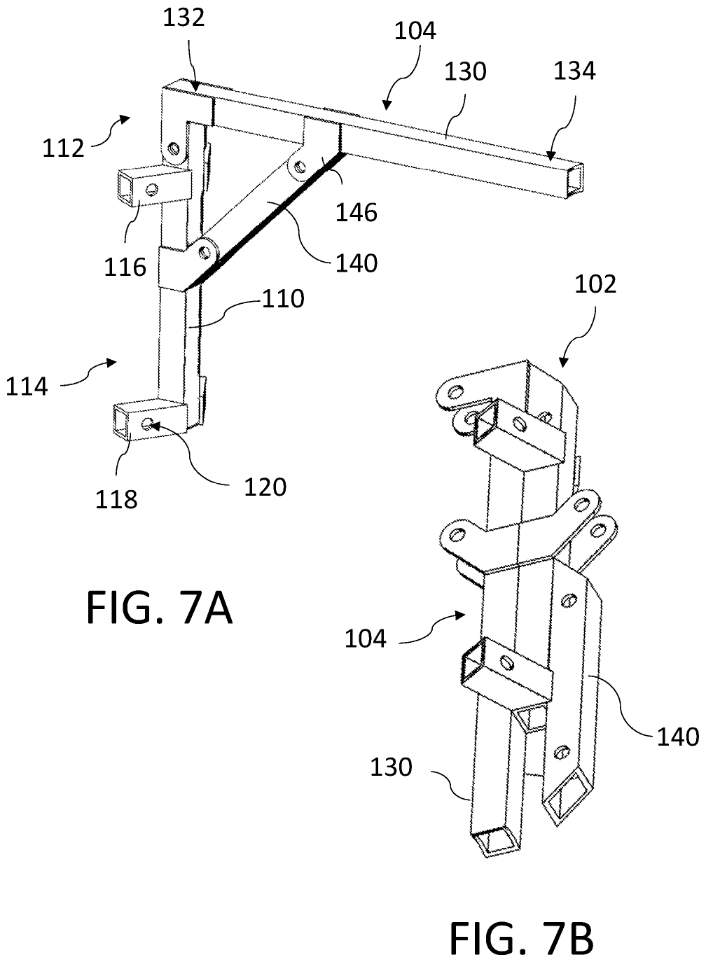

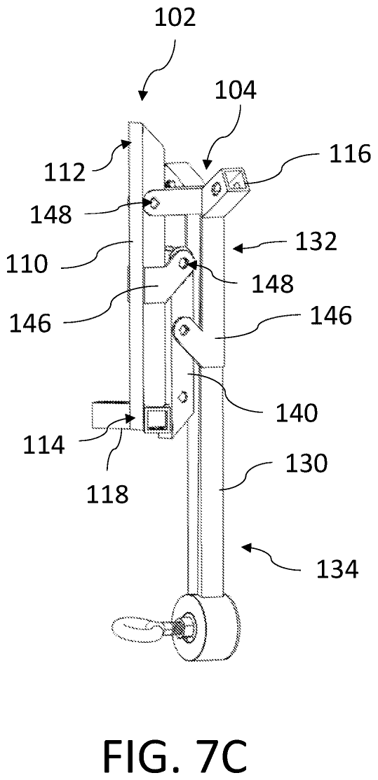

The extension member 104 of the bracket 100 includes a horizontal member 130 extending from the vertical member 110. The horizontal member 130 is illustrated extending from the first end 112 of the vertical member 110, however, it is contemplated that the horizontal member 130 may extend from the vertical member 110 from a variety of positions including the second end 114 or any position between the first and second end 112, 114. The horizontal member 130 includes a first end 132 and a second end 134. The first end 132 is coupled to the vertical member 110. The coupling may be a permanent coupling, a removable coupling, a hinged coupling, and so forth. For example, FIGS. 7A and 7B illustrate a hinged coupling between the vertical member 110 and the horizontal member 130. The horizontal member 130 is configured to space the safety strap coupling member 106 away from the tree. The length of the horizontal member 130 may be provided at different lengths in order to provide the appropriate spacing from the tree in order to optimize safety and usability.

In some embodiments, a brace member 140 may be coupled between the mounting portion 102 and the extension member 104. For example, as illustrated in FIG. 2, the brace member 140 is coupled to the vertical member 110 at a position between the first end 112 and the second end 114 and is coupled to the horizontal member 130 between the first end 132 and the second end 134. This allows for the load to be distributed through the brace member 140. The brace member 140 may be permanently coupled to the mounting portion 102 and the extension member 104, removably coupled to the mounting portion 102 and the extension member 104, or hingedly coupled to one of the mounting portion 102 and the extension member 104. The mounting portion 102 and the extension member 104 may each include coupling features 146 for coupling to the brace member 140. In one non-limiting embodiment, the mounting portion 102 and the extension member 104 may each include coupling features 146 in the form of braces including apertures 148 through which pins or fasteners may extend to couple the brace member 140 (e.g., via apertures 149) to each of the mounting portion 102 and the extension member 104. The coupling features 146 may be provided integral with the bracket 100 or may be coupled to components of the bracket 100 (e.g., via welding, fasteners, and so forth). In some embodiments, the coupling features 146 may provide a pivot point at which the vertical member 110, the horizontal member 130, and/or the brace member 140 are rotatably coupled. For example, FIG. 7C illustrates the vertical member 110 rotatably coupled to the horizontal member 130 via the coupling member 146. The coupling member 146 is fixedly coupled to one of the vertical member 110 and the horizontal member 130 and the other of the vertical member 110 and the horizontal member 130 includes an aperture positioned such that it aligns with aperture 148 of the coupling member 146. A pin (not shown) or bolt (not shown) may be inserted therethrough such that the pin or bolt defines an axis of rotation. Similarly, the brace member 140 may be coupled to one of the vertical member 110 and the horizontal member 130 in a rotatable relationship vie the coupling member 146.

Referring to FIGS. 2-6, the safety strap coupling member 106 of the bracket 100 is coupled to the second end 134 of the horizontal member 130. The safety strap coupling member 106 is positioned spaced from the vertical member 110 and provides the structure necessary to couple a safety strap 300 to the bracket 100. In some embodiments, at least a portion of the safety strap coupling member 106 is operable to rotate relative to the extension member 104. This allows the safety strap 300 to be able to rotate without causing twisting of the safety strap 300 during use and thus reducing tangles and twisting.

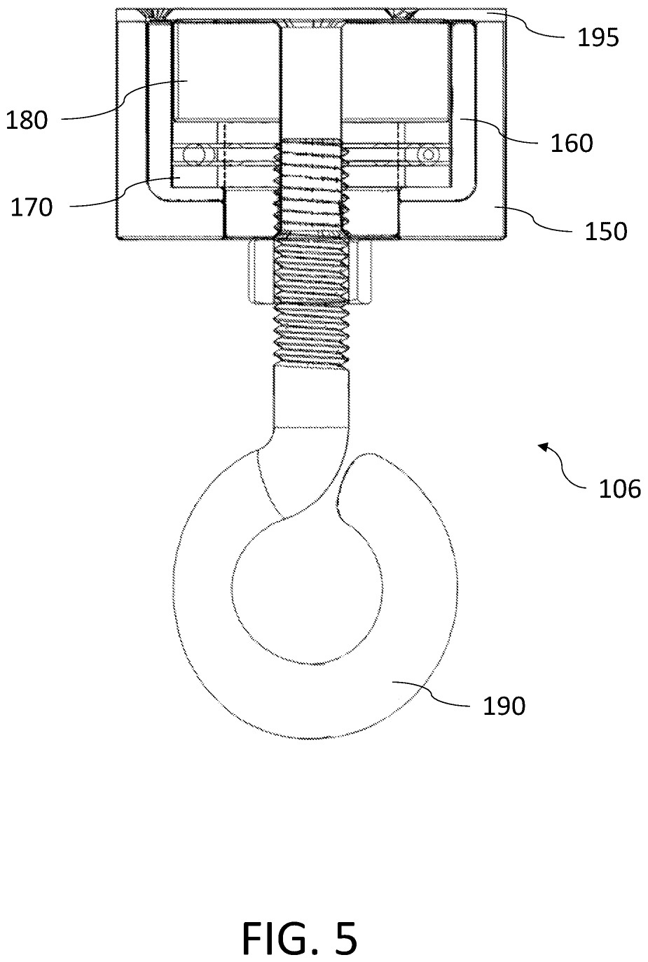

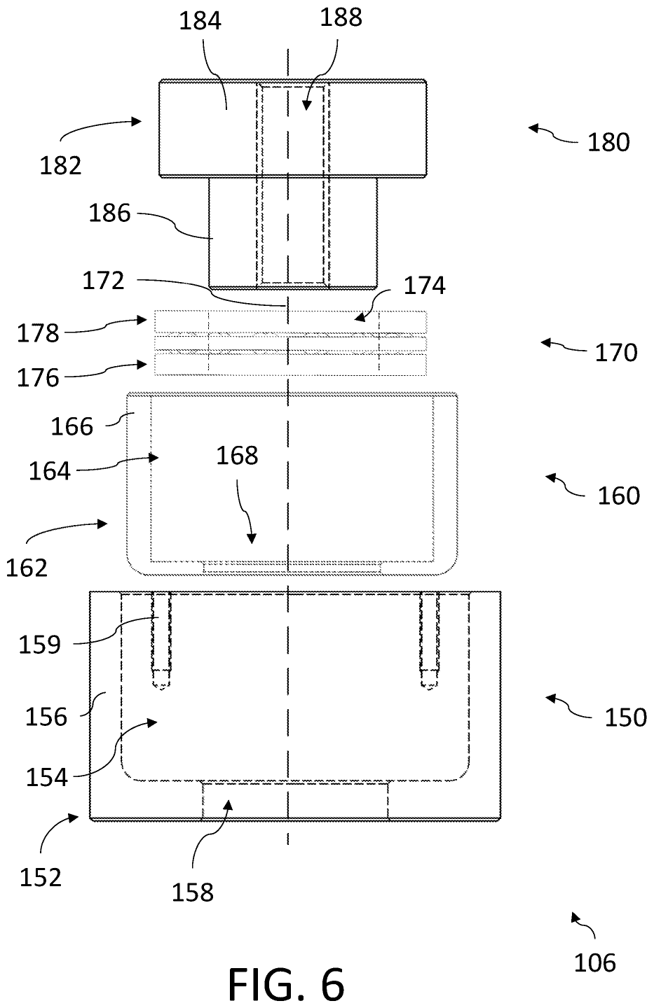

Referring to FIGS. 5 and 6, in some embodiments the safety strap coupling member 106 includes a housing 150 coupled to the extension member 104, a sound dampening insert 160 positioned in the housing 150, a bearing 170 positioned against the sound dampening insert 160, an interface member 180 positioned against the bearing 170 and operable to rotate with the bearing 170, and a coupling member 190 coupled to the interface member 180 and operable to couple to a safety strap 300.

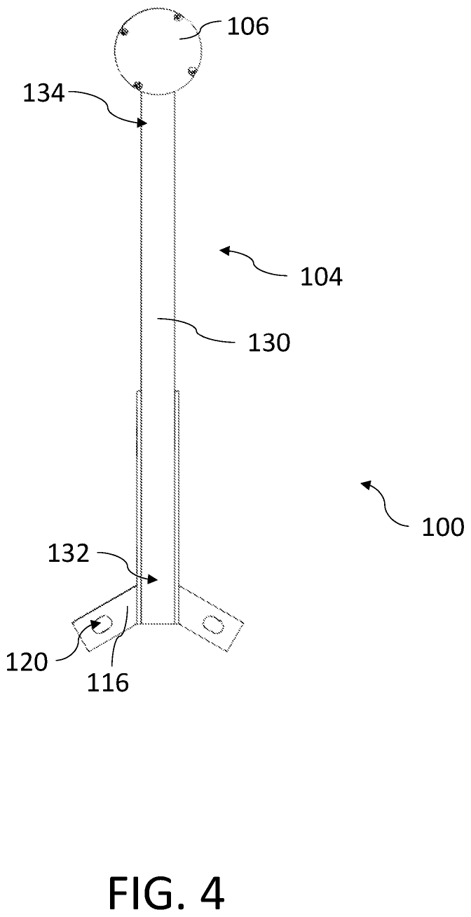

In some embodiments, the housing 150 is coupled to the extension member 104 by welding the housing 150 to the extension member 104 (see FIGS. 3 and 4). The housing 150 includes a body 152 defining a recess 154 defined by side walls 156 for receiving the sound dampening insert 160. The body 152 also defines an aperture 158 defined through a portion of the side wall 156. The aperture 158 is sized to allow at least a portion of the coupling member 190 to extend therethrough. In some embodiments, at least a portion of the interface member 180 is positioned in the aperture 158 of the housing 150 (see FIG. 5). The housing 150 provides the structure support for the remaining components of the safety strap coupling member 106. The housing 150 may also including receivers 159 for receiving fasteners to couple a cover 195 for enclosing the safety strap coupling member 106.

The sound dampening insert 160 is configured to be received by the housing 150 and is configured to receive the bearing 170. The sound dampening insert 160 is operable to reduce noise production or the level of noise produced when the safety strap coupling member 106 is rotating. The sound dampening insert 160 includes a body 162 that defines a recess 164 defined by side walls 166 for receiving the bearing 170. The body 162 also defines an aperture 168 defined through a portion of the side wall 166. The aperture 168 is sized to allow at least a portion of the coupling member 190 to extend therethrough. In some embodiments, at least a portion of the interface member 180 is positioned in the aperture 168 of the housing 150 (see FIG. 5). The coupling member 190 and the interface member 180 extend through at least a portion of the apertures 158, 168 of the housing 150 and the sound dampening insert 160. The sound dampening insert 160 may be formed of a variety of materials configured to reduce vibration and sound emission including polymers, rubbers, silicone, and so forth.

The bearing 170 is defined around and configured to rotate about a central axis 172. The bearing defines a central aperture 174 defined about the central axis 172, and similar to the apertures 158, 168 of the housing 150 and the sound dampening insert 160, is configured to receive a portion of the coupling member 190 extending therethrough and at least a portion of the interface member 180 (see FIG. 5). Any number of bearings 170 may be implemented and are within the scope of the disclosure. A first portion 176 of the bearing 170 is configured to be stationary relative to the sound dampening insert 160 and a second portion 178 is configured to rotate relative to the sound dampening insert 160. This allows for a portion of the safety strap coupling member 106 to rotate.

The interface member 180 is operable to interface with the second portion 178 of the bearing 170 such that the interface member 180 rotates relative to the first portion 176 of the bearing, the sound dampening insert 160, and the housing 150. The interface member includes a body 182 defining a cap portion 184 and an extension portion 186. The cap portion 184 is operable to interface with the second portion 178 of the bearing 170 (e.g., an upper surface). The extension portion 186 is operable to extend into at least a portion of the central aperture 174 of the bearing 170. The extension portion 186 may optionally extend into the apertures 158, 168 of the housing 150 and the sound dampening insert 160 such that the lower surface of the extension portion 186 is substantially flush with the housing 150. The interface member 180 further defines a receiver 188 which is operable to receive a portion of the coupling member 190. The receiver 188 may be a threaded aperture to receive the threaded portion of an eye bolt. However, various receivers and coupling members 190 are contemplated herein and are not to be limited to this specific arrangement.

Referring to FIGS. 7A and 7B, the bracket 100 is illustrated in a deployed configuration and in a collapsed configuration. In some embodiments, the bracket 100 may be collapsed for travelling. As previously discussed the vertical member 110 and horizontal member 130 may be hingedly or removable coupled to facilitate collapsing of the bracket to a smaller size. In the embodiments in which the vertical member 110 and horizontal member 130 are hingedly coupled, the vertical member 110 and horizontal member 130 are configured to moved from a substantially perpendicular orientation to a substantially parallel orientation. The brace member 140 may also be hingedly coupled to one of the brace member 140 such that it can change configurations from an angled orientation to a substantially parallel orientation with the vertical member 110 and horizontal member 130 when in the collapsed configuration.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A safety system for mounting to a tree comprising:
a bracket including a mounting portion configured to be positioned against the tree and an extension member including a first end extending from the mounting portion and a second end spaced from the mounting portion, the second end including a safety strap coupling member operable to couple to a safety strap; and
a securing strap configured to couple to the mounting portion of the bracket and secure the bracket to the tree.

2. The safety system of claim 1, further comprising a harness and a safety strap, the harness operable to be positioned on a user and the safety strap operable to couple to the safety strap coupling member and the harness.

3. The safety system of claim 1, wherein at least a portion of the safety strap coupling member is operable to rotate relative to the extension member.

4. The safety system of claim 3, wherein the safety strap coupling member comprises:
a housing coupled to the extension member;
a sound dampening insert positioned in the housing;
a bearing positioned against the sound dampening insert;
an interface member positioned against the bearing and operable to rotate with the bearing; and
a coupling member coupled to the interface member and operable to couple to a safety strap.

5. The safety system of claim 1, wherein the mounting portion comprises:
a vertical member including a first end and a second end;
a first set of arms extending from the vertical member proximate the first end; and
a second set of arms extending from the vertical member proximate the second end,
wherein the securing strap includes a first securing strap operable to couple to the first set of arms and a second securing strap operable to couple to the second set of arms to secure the bracket to the tree.

6. The safety system of claim 5, wherein the first set of arms extend generally horizontally from the vertical member and define an angle from about 90 degrees to about 180 degrees therebetween and the second set of arms extend generally horizontally from the vertical member and define an angle from about 90 degrees to about 180 degrees therebetween.

7. The safety system of claim 1, wherein the bracket includes a brace coupled to the mounting portion and the extension member.

8. The safety system of claim 7, wherein the brace is rotatably coupled to one of the mounting portion and the extension member.

9. The safety system of claim 1, wherein the extension member is rotatably coupled to the mounting portion.

10. A bracket for mounting to a tree and securing a safety strap, the bracket comprising:
a mounting portion including a vertical member configured to be positioned against a tree and at least one pair of arms configured to couple to a securing strap to couple the bracket to the tree, the at least one pair of arms operable to limit rotation of the vertical member relative to the tree when secured;
an extension member including a first end extending from the mounting portion and a second end spaced from the mounting portion; and
a safety strap coupling member positioned proximate the second end of the extension member and operable to couple to a safety strap.

11. The bracket of claim 10, wherein the at least one pair of arms includes a first pair of arms coupled to the vertical member at an upper portion and a second pair of arms coupled to the vertical member at a lower portion.

12. The bracket of claim 10, wherein the at least one pair of arms are angled relative to each other from about 120 degrees to about 170 degrees.

13. The bracket of claim 10, further comprising a support bracket extending between an intermediate portion of the vertical member and an intermediate portion of the extension member.

14. The bracket of claim 13, wherein the support bracket is rotatably coupled to one of the vertical member and the extension member.

15. The bracket of claim 10, wherein the extension member is rotatably coupled to the vertical member.

16. The bracket of claim 10, wherein the safety strap coupling member includes:
a housing coupled to the extension member;
a sound dampening insert positioned in the housing;
a bearing positioned against the sound dampening insert;
an interface member positioned against the bearing and operable to rotate with the bearing; and
a coupling member coupled to the interface member and operable to couple to a safety strap.

17. The bracket of claim 10, further comprising tabs defining apertures through which fasteners are secured to maintain predetermined orientations between the vertical member and the extension member.

18. A safety strap coupling member comprising:
a housing configured to be coupled to a bracket for interfacing to a tree;
a sound dampening insert positioned in the housing;
a bearing positioned against the sound dampening insert;
an interface member positioned against the bearing and operable to rotate with the bearing; and
a coupling member coupled to the interface member and operable to couple to a safety strap.

19. The safety strap coupling member of claim 18, wherein the housing includes a recess defined by side walls for receiving the sound dampening insert and an aperture defined through a portion of the side walls, the sound dampening insert including a recess defined by side walls for receiving the bearing and an aperture defined through a portion of the side walls, the coupling member operable to extend through at least a portion of the aperture of the sound dampening insert and at least a portion of the aperture of the housing.

20. The safety strap of claim 19, wherein the bearing is defined around and configured to rotate about a central axis, the bearing defining a central aperture defined about the central axis, and wherein the interface member includes a body defining a cap portion and an extension member, the cap portion operable to interface with an upper surface of the bearing and the extension member operable to extend into at least a portion of the central aperture of the bearing.
